(19) United States
(12) Patent Application Publication
(10) Pub. No.: US 2014/0313661 A1
(43) Pub. Date: Oct. 23, 2014

(54) EXPANSION CARD ASSEMBLY AND ELECTRONIC DEVICE USING THE SAME

(71) Applicant: HON HAI PRECISION INDUSTRY CO., LTD., New Taipei (TW)

(72) Inventor: SHENG-HAN LIN, New Taipei (TW)

(73) Assignee: HON HAI PRECISION INDUSTRY CO., LTD., New Taipei (TW)

(21) Appl. No.: 13/893,353

(22) Filed: May 14, 2013

(30) Foreign Application Priority Data
Apr. 19, 2013 (TW) 102114096

(51) Int. Cl. G06F 1/18; G06F 1/20

(52) U.S. Cl. CPC G06F 1/186; G06F 1/20
USPC 361/679.32; 248/205.1

(57) ABSTRACT

An expansion card assembly includes an expansion card, a bracket, a heat sink mounted to the expansion card, and an uninterruptible power supply (UPS). The bracket includes a shell and an installing member mounted to the shell. The shell includes a latching portion. When mounting the UPS, the shell receives the UPS and is detachably mounted to the expansion card. The UPS is sandwiched between the shell and the installing member, and the latching portion detachably latched to the heat sink.

### BACKGROUND

1. Technical Field

The disclosure relates to electronic devices, and particularly to an electronic device equipped with an expansion card.

2. Description of Related Art

A bracket is often mounted to an expansion card in an electronic device enclosure to attach uninterruptible power supplies by screwing. However, it is inconvenient to screw or unscrew the uninterruptible power supplies for maintenance or replacement.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an embodiment of an electronic device, wherein the electronic device includes an expansion card assembly and an enclosure.

FIG. 2 is similar to FIG. 1, but viewed from another perspective and with the enclosure omitted, wherein the expansion card assembly includes a shell.

FIG. 3 is an enlarged, isometric view of the shell of FIG. 2.

FIG. 4 is a partially assembled, isometric view of FIG. 2.

FIG. 5 is an assembled, isometric view of FIG. 1.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

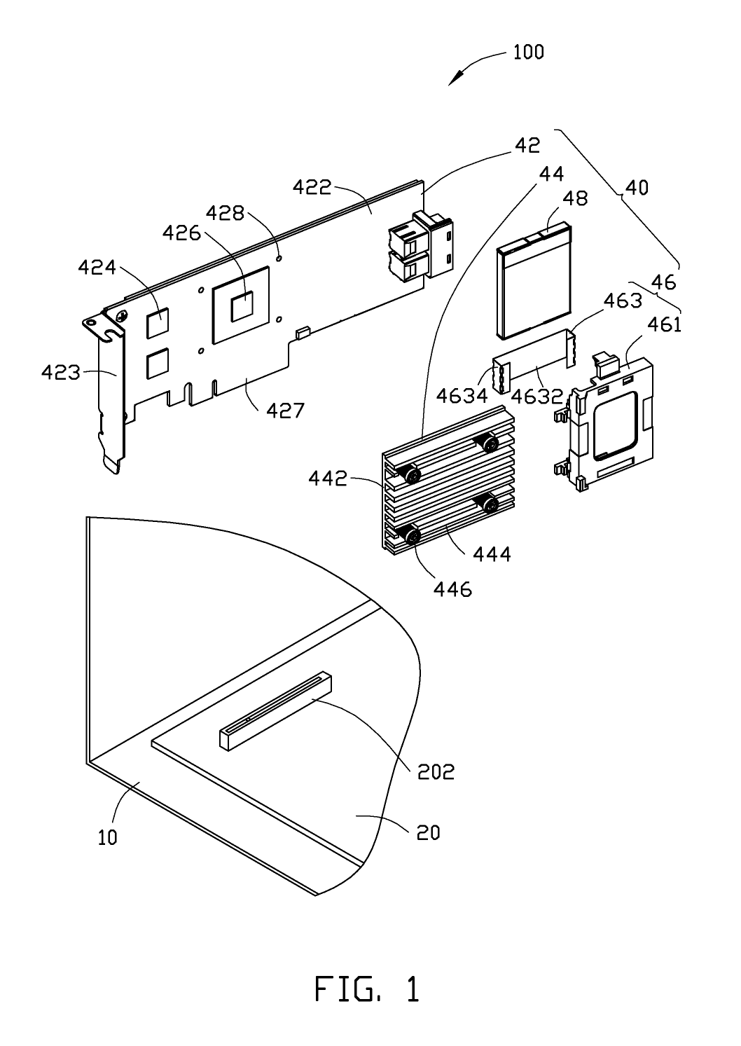

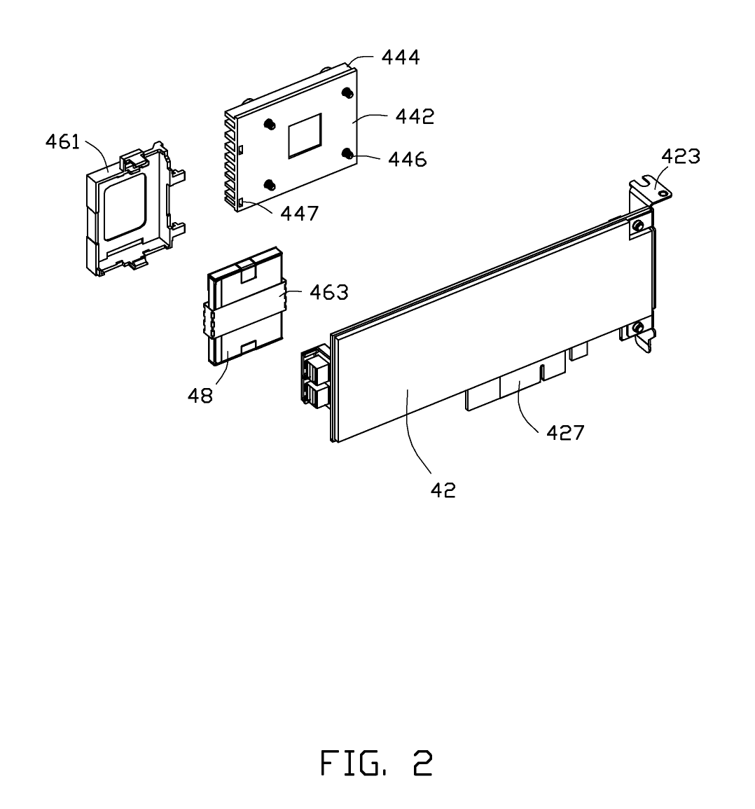

FIGS. 1-2 show an exemplary embodiment of an electronic device 100. The electronic device 100 includes an enclosure 10, a circuit board 20 mounted in the enclosure 10, and an expansion card assembly 40. An expansion slot 202 is mounted on the circuit board 20. In the embodiment, the electronic device 100 is a server.

The expansion card assembly 40 includes an expansion card 42, a heat sink 44, the bracket 46, and an rectangular uninterruptible power supply (UPS) 48. The bracket 46 includes a shell 461 and an installing member 463.

The expansion card 42 includes a rectangular circuit board 422, a positioning piece 423 mounted on an end of the circuit board 422, a plurality of components 424 mounted on the circuit board 422, and a chip 426 mounted on the circuit board 422. An edge connector 427 extends down from a bottom side of the circuit board 422. The circuit board 422 defines four mounting holes 428 around the chip 426.

The heat sink 44 includes a rectangular base 442, a plurality of fins 444 perpendicularly extending out from a first surface of the base 442, and four fasteners 446 extending through four corners of the base 442. An end of the base 442 defines two latching holes 447 in a second surface opposite to the fins 444.

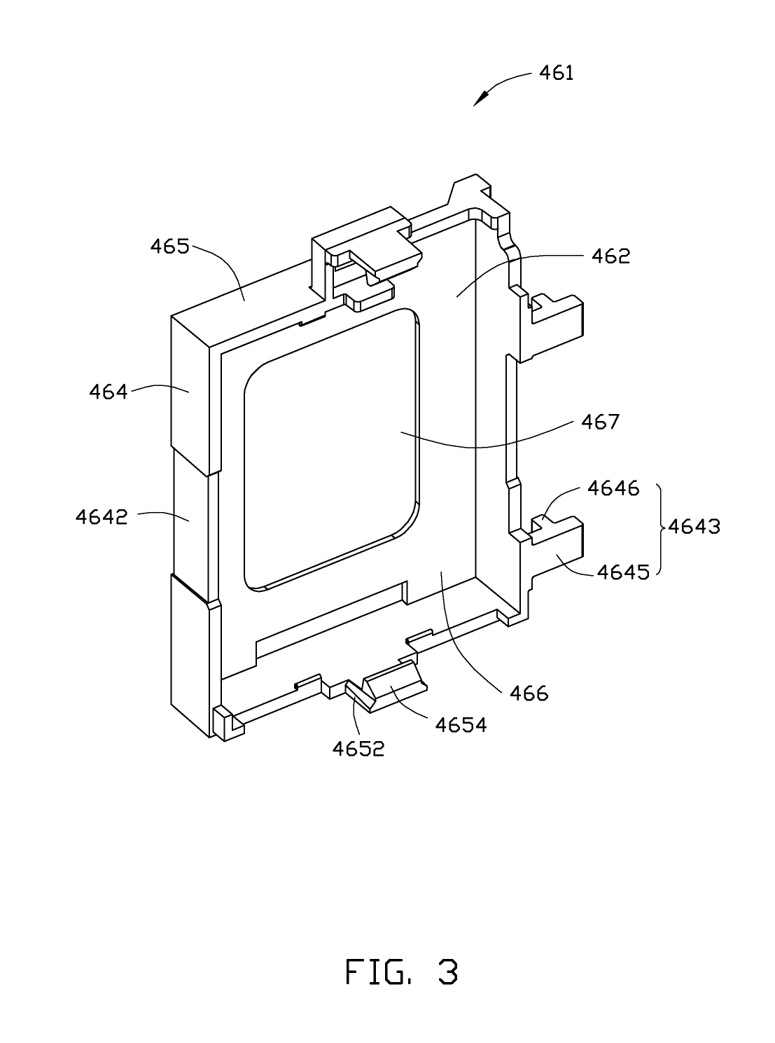

FIG. 3 shows the shell 461. The shell 461 includes a rectangular supporting plate 462, two side plates 464 perpendicularly extending out from two opposite sides of the supporting plate 462, and two end plates 465 perpendicularly extending out from two opposite ends of the supporting plate 462 and connected between corresponding ends of the side plates 464. The supporting plate 462, the side plates 464, and the end plates 465 cooperatively bound a receiving space 466. A middle of the supporting plate 462 defines a vent 467 communicating with the receiving space 466. A middle of an outer surface of each side plate 464 defines a latching slot 4642 extending through an outer surface of the supporting plate 462 and a side of the side plate 464 opposite to the supporting plate 462. Two latching portions 4643 protrude out from two ends of one of the side plates 464, extending away from the other side plate 464. Each latching portion 4643 includes a resilient extending plate 4645 perpendicularly extending out from the side plate 464, and a latching block 4646 perpendicularly extending from a middle of the extending plate 4645 toward the supporting plate 462. Two opposite and resilient hooks 4652 protrude out from middles of the end plates 465 away from the supporting plate 462. The hooks 4652 define two slanting guiding surfaces 4654 facing each other.

The installing member 463 is substantially U-shaped, and includes a rectangular positioning plate 4632 and two L-shaped latching plates 4634 first extending out from two opposite ends of the positioning plate 4632 then extending toward each other.

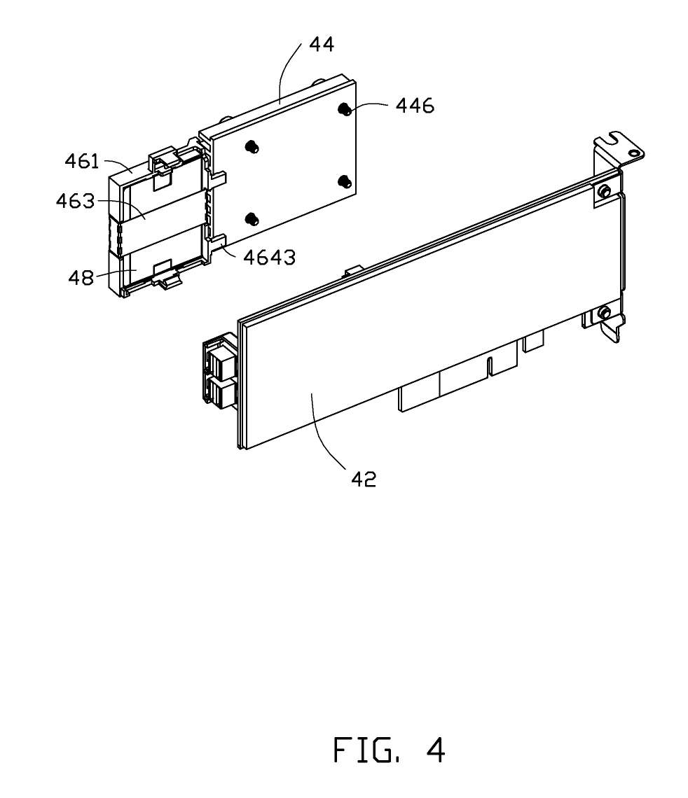

FIG. 4 shows that in assembly of the expansion card assembly 40. The UPS 48 is received in the receiving space 466 of the shell 461. The latching plates 4634 are deformed away from each other. A combination of the UPS 48 and the shell 461 is received in the installing member 463 between the latching plates 4634, with the latching plates 4634 aligning with the latching slots 4642. The latching plates 4634 are restored to allow the latching plates 4634 to latch into the latching slots 4642 of the shell 461. Therefore, the UPS 48 is sandwiched between the shell 461 and the installing member 463. The latching blocks 4646 of the latching portions 4643 are inserted into the latching holes 447 of the heat sink 44. A combination of the heat sink 44 and the bracket 46 is mounted on the circuit board 422 of the expansion card 42, with the base 442 contacting the chip 426 and the hooks 4652 aligning with two opposite sides of the circuit board 422. The fasteners 446 align with the mounting holes 428 of the circuit board 422. The bracket 46 is pressed toward the circuit board 422, and the guiding surfaces 4654 are slidably abutted against the sides of the circuit board 422, deforming the hooks 4652, until the hooks 4652 pass through the circuit board 422. The hooks 4652 are restored to latch an outer surface of the circuit board 422 opposite to the chip 426. The fasteners 446 are latched into the mounting holes 428 of the circuit board 422.

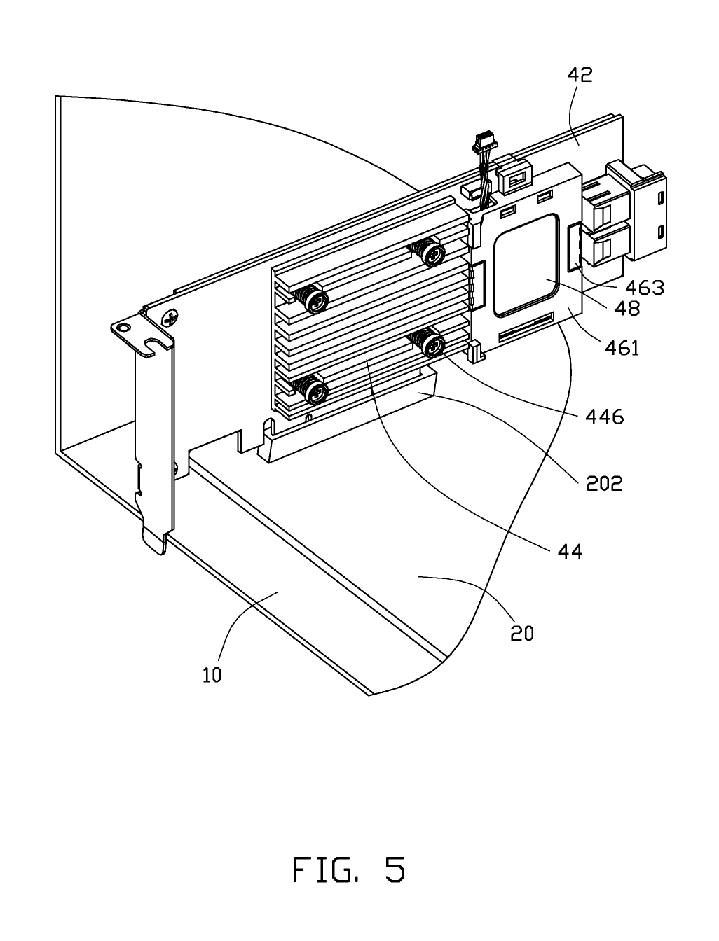

FIG. 5 shows that in assembly of the expansion card assembly 40 to the enclosure 10. The edge connector 427 of the expansion card 42 is inserted into the expansion slot 202, and the positioning piece 423 is mounted to the enclosure 10.

To detach the UPS 48, the expansion card assembly 40 is pulled up from the circuit board 20, to allow the edge connector 427 of the expansion card 42 to detach from the expansion slot 202. The hooks 4652 of the shell 461 are deformed away from each other, to disengage from the circuit board 422 of the expansion card 42. The latching plates 4634 are deformed away from each other, until the latching plates 4634 are disengaged from the latching slots 4642 of the shell 461. Therefore, the UPS 48 can be easily detached from the bracket 46.

The UPS 48 is received in the bracket 46, the hooks 4652 of the bracket 46 are latched into the circuit board 422, and the latching portions 4643 are positioned to the heat sink 44, so the UPS 48 is firmly mounted on the circuit board 422, to dampen vibrations of the UPS 48 and avoid deformation of the circuit bard 422.

It is believed that the present embodiment and its advantages will be understood from the foregoing description, and it will be apparent that various changes may be made thereto without departing from the spirit and scope of the description or sacrificing all of their material advantages, the example hereinbefore described merely being exemplary embodiment.

What is claimed is:

1. A bracket for mounting an uninterruptible power supply (UPS) to an expansion card, comprising:
a shell comprising a latching portion; and
an installing member mounted to the shell to sandwich the UPS with the shell;
wherein when mounting the UPS, the shell receives the UPS and is detachably mounted to the expansion card, and the latching portion detachably latches to a heat sink fixed on the expansion card.

2. The bracket of claim 1, wherein the shell comprises a supporting plate, two side plates extending from opposite sides of the supporting plate, and two end plates extending from opposite ends of the supporting plate, wherein the supporting plate, the side plates, and the end plates cooperatively bound a receiving space for receiving the UPS, wherein the latching portion extends from one of the side plates, two hooks extend from the end plates and detachably latch opposite sides of the expansion card.

3. The bracket of claim 2, wherein the installing member comprises a positioning plate sandwiching the UPS with the supporting plate of the shell, and two resilient latching plates extending out from two opposite ends of the positioning plate, to latch the side plates of the shell.

4. An expansion card assembly, comprising:
an expansion card;
a bracket comprising a shell and an installing member mounted to the shell;
a heat sink mounted to the expansion card; and
an uninterruptible power supply (UPS);
wherein the shell comprises a latching portion, when mounting the UPS, the shell receives the UPS and is detachably mounted to the expansion card, the UPS is sandwiched between the shell and the installing member, and the latching portion detachably latched to the heat sink.

5. The expansion card assembly of claim 4, wherein the heat sink comprises a base contacting a chip of the expansion card, the base defines a latching hole, a latching portion protrudes out from the bracket, and detachably latches in the latching hole of the heat sink.

6. The expansion card assembly of claim 5, wherein the bracket comprises a shell, the UPS is received in the shell, two resilient hooks extend out from the shell to latch to two opposite sides of the expansion card.

7. The expansion card assembly of claim 6, where the latching portion comprises a resilient extending plate extending out from the shell, and a latching block extending from the extending plate to latch in the latching hole of the heat sink.

8. The expansion card assembly of claim 7, wherein the shell includes a rectangular supporting plate, two side plates extending out from two opposite sides of the supporting plate, and two end plates extending out from two opposite ends of the supporting plate and connected between the side plates, the supporting plate, the side plates, and the end plates cooperatively bound a receiving space for receiving the UPS, the hooks are extend out from the end plates of the shell, the extending plate is extended out from one of the side plates of the shell adjacent to the heat sink.

9. The expansion card assembly of claim 8, wherein an outer surface of each side plate of the shell defines a latching slot extending through an outer surface of the supporting plate opposite to the receiving space, the installing member comprises a positioning plate sandwiching the UPS with the supporting plate of the shell, and two resilient latching plates extending out from two opposite ends of the positioning plate, to latch in the latching slots of the shell.

10. The expansion card assembly of claim 6, wherein the hooks define two slanting guiding surfaces facing each other.

11. The expansion card assembly of claim 5, wherein a plurality of fasteners extends through the heat sink and engages in a plurality of mounting holes defined in the expansion card around the chip.

12. An electronic device, comprising:
an enclosure;
a circuit board mounted in the enclosure, and comprising an expansion slot; and
an expansion card assembly comprising an expansion card connected to the expansion slot, a bracket, a heat sink mounted to the expansion card, and an uninterruptible power supply (UPS);
wherein the bracket comprises a shell and an installing member mounted to the shell, the shell comprises a latching portion, when mounting the UPS, the shell receives the UPS and is detachably mounted to the expansion card, the UPS is sandwiched between the shell and the installing member, and the latching portion detachably latched to the heat sink.

13. The electronic device of claim 12, wherein the heat sink comprises a base contacting a chip of the expansion card and a plurality of fins extending from the base away from the expansion card, the base defines a latching hole, a latching portion protrudes out from the bracket, to latch in the latching hole of the heat sink.

14. The electronic device of claim 13, wherein the bracket comprises a shell, the UPS is received in the shell, two resilient hooks extend out from the shell to latch to two opposite sides of the expansion card.

15. The electronic device of claim 14, where the latching portion comprises a resilient extending plate extending out from the shell, and a latching block extending from the extending plate to latch in the latching hole of the heat sink.

16. The electronic device of claim 15, wherein the shell includes a rectangular supporting plate, two side plates extending out from two opposite sides of the supporting plate, and two end plates extending out from two opposite ends of the supporting plate and connected between the side plates, the supporting plate, the side plates, and the end plates cooperatively bound a receiving space for receiving the UPS, the hooks are extend out from the end plates of the shell, the extending plate is extended out from one of the side plates of the shell adjacent to the heat sink.

17. The electronic device of claim 16, wherein the an outer surface of each side plate of the shell defines a latching slot extending through an outer surface of the supporting plate opposite to the receiving space, the installing member comprises a positioning plate sandwiching the UPS with the supporting plate, and two resilient latching plates extending out from two opposite ends of the positioning plate, to latch in the latching slots of the shell.

18. The electronic device of claim 15, wherein the supporting plate defines a vent communicating with the receiving space.

19. The electronic device of claim 14, wherein the hooks define two slanting guiding surfaces facing each other.

20. The electronic device of claim 13, wherein a plurality of fasteners extends through the heat sink and engages in four mounting holes defined in the expansion card around the chip.
